(19) United States
(12) Patent Application Publication
(10) Pub. No.: US 2026/0171299 A1
(43) Pub. Date: Jun. 18, 2026

(54) INDUCTOR COMPONENT

(71) Applicant: Murata Manufacturing Co., Ltd., Kyoto-fu (JP)

(72) Inventor: Atsushi SEKO, Nagaokakyo-shi (JP)

(73) Assignee: Murata Manufacturing Co., Ltd., Kyoto-fu (JP)

(21) Appl. No.: 19/411,562

(22) Filed: Dec. 8, 2025

(30) Foreign Application Priority Data
Dec. 17, 2024 (JP) 2024-220739

(51) Int. Cl. H01F 27/28; H01F 27/29

(52) U.S. Cl. CPC H01F 27/2823; H01F 27/29

(57) ABSTRACT

An inductor component includes a main body, a coil inside the main body and wound helically around a coil axis, first and second outer electrodes exposed at a surface of the main body, a first extended wire inside the main body and electrically connecting one end portion of the coil to the first outer electrode, and a second extended wire inside the main body and electrically connecting an opposite end portion of the coil to the second outer electrode. The main body contains an insulator and has a mounting surface extending parallel to a coil-axis direction and a top surface opposite to the mounting surface in a height direction that is perpendicular to the coil-axis direction. The first and second outer electrodes are exposed at least at the mounting surface of the main body and spaced from each other.

### CROSS-REFERENCE TO RELATED APPLICATION

This application claims benefit of priority to Japanese Patent Application No. 2024-220739, filed Dec. 17, 2024, the entire content of which is incorporated herein by reference.

### BACKGROUND

### Technical Field

The present disclosure relates to an inductor component.

### Background Art

Japanese Patent No. 6787286 discloses a method of manufacturing an inductor component. The method includes a step of preparing an insulating paste that is photosensitive and that includes a filler material composed of quartz, a glass material and a resin material, and a conductive paste; a step of forming a first insulating layer by applying the insulating paste; a step of exposing the first insulating layer in a state where a first portion of the first insulating layer is shielded by a mask; a step of removing the first portion of the first insulating layer to form a groove at a position corresponding to the first portion, a depth of the groove being greater than a depth of the groove; a step of applying the conductive paste in the groove to form a coil conductor layer in the groove; and a step of applying the insulating paste on the first insulating layer and the coil conductor layer to form a second insulating layer.

### SUMMARY

According to the method of manufacturing the inductor component of Japanese Patent No. 6787286, the aspect ratio and the cross-sectional area of the coil conductor layer can be increased, thereby improving the coil characteristics.

In many cases, multilayer inductors are manufactured by sintering multilayer bodies made of a metal paste and an insulating paste. The wire material is mainly made of a metal, and the insulating material is made of a ceramic material or a magnetic substance. In such cases, the wire material and the insulating material are different in the coefficient of linear expansion. In the inductor component manufactured according to the method described in Japanese Patent No. 6787286, increasing the wire thickness in the lamination direction increases the volume of the wire occupying in a unit volume of the insulating layer, which consequently increases the residual stress generated in the cooling process after sintering and accordingly decreases the resistance against external impact. This may lead to a problem that the degradation of the resistance against external impact accelerates breakage and cracks (hereinafter called “cracks or the like”) of a product.

To control the degradation of the resistance against external impact, it is effective to reduce stress resultant, and it is in fact possible to reduce the stress resultant by reducing the volume of the coil wire locally. However, decreasing the cross-sectional area of the coil wire may lead to the degradation of the Q characteristics (i.e., Q-value).

Accordingly, the present disclosure provides an inductor component that can reduce the occurrence of cracks or the like while controlling the degradation of the Q characteristics.

According to an aspect of the disclosure, an inductor component includes a main body, a coil disposed inside the main body and wound helically around a coil axis, a first outer electrode and a second outer electrode exposed at a surface of the main body, a first extended wire disposed inside the main body and electrically connecting one end portion of the coil to the first outer electrode, and a second extended wire disposed inside the main body and electrically connecting an opposite end portion of the coil to the second outer electrode. The main body contains an insulator, and the main body has a mounting surface extending parallel to a coil-axis direction and a top surface positioned opposite to the mounting surface in a height direction that is perpendicular to the coil-axis direction. The first outer electrode and the second outer electrode are exposed at least at the mounting surface of the main body so as to be spaced from each other. The coil includes a plurality of coil wires that are connected electrically to each other. The coil wires extend in directions perpendicular to the coil-axis direction. The coil wires are disposed at different positions in the coil-axis direction and are electrically connected to each other. As viewed in the coil-axis direction, the plurality of coil wires includes at least one straight portion and at least one curved portion. The at least one curved portion has a cut-away section formed so as to extend partially across the curved portion in the coil-axis direction. A wire thickness in the coil-axis direction at the cut-away section is smaller than a wire thickness in the coil-axis direction at the at least one straight portion.

The present disclosure can provide an inductor component that can reduce the occurrence of cracks or the like while controlling the degradation of the Q characteristics.

### BRIEF DESCRIPTION OF THE DRAWINGS

FIG. 1 is a perspective view schematically illustrating an example of an inductor component according to Embodiment 1 of the present disclosure;

FIG. 2 is an exploded perspective view schematically illustrating the example of the inductor component of FIG. 1;

FIG. 3 is a plan view schematically illustrating the example of the inductor component of FIG. 1 as viewed in a coil-axis direction;

FIG. 4 is a view illustrating a distribution of residual stress of a known inductor component after sintering;

FIG. 5 is a view illustrating a distribution of density of a current flowing in a coil of a known inductor component;

FIG. 6 is an example schematic cross section of the inductor component of FIG. 1, the cross section being taken along line a1-a2;

FIG. 7 is a perspective view schematically illustrating another example (Variation 1) of the inductor component of FIG. 1;

FIG. 8 is an example schematic cross section of the inductor component of FIG. 7, the cross section being taken along line b1-b2;

FIG. 9 is a perspective view schematically illustrating another example (Variation 2) of the inductor component of FIG. 1;

FIG. 10 is an example schematic cross section of the inductor component of FIG. 9, the cross section being taken along line c1-c2;

FIG. 11 is a view illustrating a distribution of density of a high-frequency current flowing through a surface of a coil of a known inductor component;

FIG. 12 is a perspective view schematically illustrating another example (Variation 3) of the inductor component of FIG. 1;

FIG. 13 is a perspective view schematically illustrating an example of an inductor component according to Embodiment 2 of the present disclosure;

FIG. 14 is a plan view schematically illustrating the example of the inductor component of FIG. 13 as viewed in a coil-axis direction;

FIG. 15 is a plan view schematically illustrating another example (Variation 1) of the inductor component of FIG. 13 as viewed in the coil-axis direction;

FIG. 16 is a plan view schematically illustrating an example of an inductor component according to Embodiment 3 of the present disclosure;

FIG. 17 is a plan view schematically illustrating another example (Variation 1) of the inductor component of FIG. 16;

FIG. 18 is a perspective view schematically illustrating another example of the inductor component of FIG. 1;

FIG. 19 is a perspective view schematically illustrating another example of the inductor component of FIG. 7; and

FIG. 20 is a perspective view schematically illustrating another example of the inductor component of FIG. 7.

### DETAILED DESCRIPTION

An inductor component of the present disclosure will be described. Note that the configurations described herein are not intended to limit the present disclosure and can be modified appropriately within the scope of the present disclosure. In addition, a combination of individual preferred configurations described herein is deemed to fall within the scope of the present disclosure.

Note that the embodiments described herein are examples and configurations described in different embodiments can be partially replaced or combined with one another. In embodiments to be described after Embodiment 1, the description will focus on differences, and the description of the same elements as those of Embodiment 1 will be omitted. The description of the same advantageous effects obtained by the same configuration in different embodiments will not be repeated.

In the following description, inductor components of various embodiments are generically referred to as the “inductor component of the present disclosure”.

Drawings to be referred to below are schematic illustrations, and accordingly dimensions, aspect ratios, or the like may be different from those of an actual product.

In the present specification, terms used to describe a relationship between elements (for example, “parallel”, “perpendicular”, “orthogonal”, and so on) or used to describe the shape of an element are not only used in their strict senses but also used in their substantially equivalent senses so as to allow for a certain range of difference, for example, a several-percent difference.

According to an aspect of the disclosure, an inductor component includes a main body, a coil disposed inside the main body and wound helically around a coil axis, a first outer electrode and a second outer electrode exposed at a surface of the main body, a first extended wire disposed inside the main body and electrically connecting one end portion of the coil to the first outer electrode, and a second extended wire disposed inside the main body and electrically connecting an opposite end portion of the coil to the second outer electrode. The main body contains an insulator, and the main body has a mounting surface extending parallel to a coil-axis direction and a top surface positioned opposite to the mounting surface in a height direction that is perpendicular to the coil-axis direction. The first outer electrode and the second outer electrode are exposed at least at the mounting surface of the main body so as to be spaced from each other. The coil includes a plurality of coil wires that are connected electrically to each other. The coil wires extend in directions perpendicular to the coil-axis direction. The coil wires are disposed at different positions in the coil-axis direction and are electrically connected to each other. As viewed in the coil-axis direction, the plurality of coil wires includes at least one straight portion and at least one curved portion. The at least one curved portion has a cut-away section formed so as to extend partially across the curved portion in the coil-axis direction. A wire thickness in the coil-axis direction at the cut-away section is smaller than a wire thickness in the coil-axis direction at the at least one straight portion.

### Embodiment 1

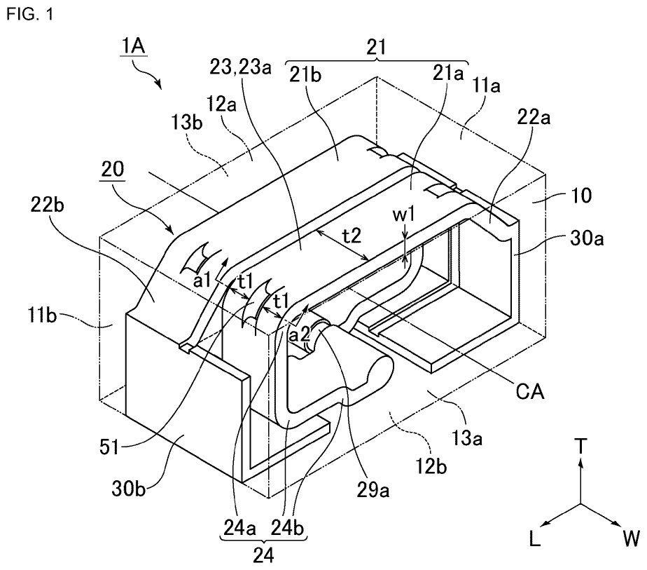

FIG. 1 is a perspective view schematically illustrating an example of an inductor component according to Embodiment 1 of the present disclosure.

As illustrated in FIG. 1, an inductor component 1A includes a main body 10, a coil 20, a first outer electrode 30a, a second outer electrode 30b, a first extended wire 22a, and a second extended wire 22b.

In the present specification, a length direction, a height direction, and a width direction are directions denoted by L, T, and W, respectively, as indicated in the drawings (for example, FIG. 1). The length direction L, the height direction T, and the width direction W orthogonally intersect each other.

As illustrated in FIG. 1, the main body 10 of the inductor component 1A has an end surface 11a and an end surface 11b that are opposite to each other in the length direction L, a top surface 12a and a bottom surface 12b that are opposite to each other in the height direction T, and a side surface 13a and a side surface 13b that are opposite to each other in the width direction W. In the inductor component 1A, the width direction W extends parallel to the coil-axis direction of the coil 20. In other words, the main body 10 of the inductor component 1A has the bottom surface 12b extending parallel to the coil-axis direction, and the main body 10 includes the top surface 12a positioned opposite to the bottom surface 12b in the height direction T that orthogonally intersects the coil-axis direction.

In the present embodiment, the width direction W is defined as the direction extending parallel to the coil-axis direction unless otherwise specified.

The bottom surface 12b of the main body 10 serves as the mounting surface of the inductor component 1A. More specifically, the bottom surface 12b of the main body 10 is the mounting surface that faces an object to be mounted on (for example, a circuit board) when the inductor component 1A is mounted. Accordingly, in the inductor component 1A, the mounting surface of the main body 10 (i.e., the bottom surface 12b of the main body 10) extends parallel to the coil-axis direction.

One of the surfaces of the main body 10, in other words, one of the end surface 11a, the end surface 11b, the top surface 12a, the bottom surface 12b, the side surface 13a, and the side surface 13b, may have a marking for distinguishing the surfaces of the main body 10 from each other easily.

The end surface 11a and the end surface 11b of the main body 10 do not need to intersect the length direction L orthogonally in its strict sense. The top surface 12a and the bottom surface 12b of the main body 10 do not need to intersect the height direction T orthogonally in its strict sense. The side surface 13a and the side surface 13b of the main body 10 do not need to intersect the width direction W orthogonally in its strict sense.

For example, the main body 10 is shaped like a cuboid as illustrated in FIG. 1.

In the present specification, the term “cuboid” refers to a shape substantially like a cuboid, which encompasses a cuboid-like shape having rounded vertices and rounded edges, which will be described later.

It is preferable that the main body 10 have rounded edges and rounded vertices. The vertices of the main body 10 are portions at which three surfaces of the main body 10 intersect. The edges of the main body 10 are portions at which two surfaces of the main body 10 intersect.

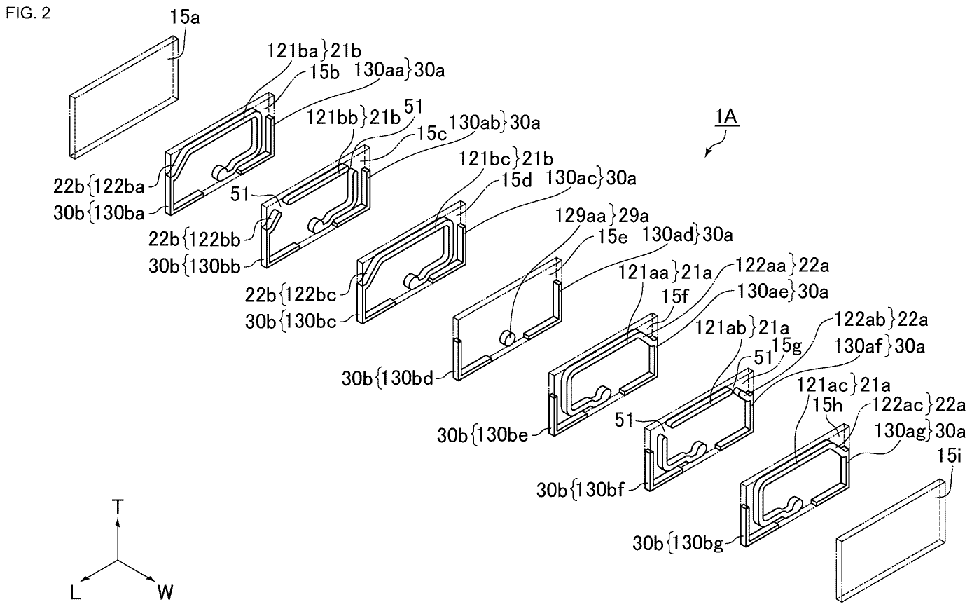

FIG. 2 is an exploded perspective view schematically illustrating the example of the inductor component of FIG. 1.

The main body 10 includes an insulator. In the example illustrated in FIG. 2, the insulator is made of multiple insulating layers that are laminated in the coil-axis direction.

In the example illustrated in FIG. 2, the insulating layers include an insulating layer 15a, an insulating layer 15b, an insulating layer 15c, an insulating layer 15d, an insulating layer 15e, an insulating layer 15f, an insulating layer 15g, an insulating layer 15h, and an insulating layer 15i. The insulating layer 15a, the insulating layer 15b, the insulating layer 15c, the insulating layer 15d, the insulating layer 15e, the insulating layer 15f, the insulating layer 15g, the insulating layer 15h, and the insulating layer 15i are laminated in this order from the side surface 13b toward the side surface 13a of the main body 10 in the coil-axis direction.

Note that these insulating layers are formed integrally and boundaries between insulating layers are not likely observed clearly.

Note that the insulating layers may further include at least one insulating layer of another type in addition to the above insulating layers. For example, at least one insulating layer may be present between the insulating layer 15a and the insulating layer 15b in the coil-axis direction. Moreover, at least one insulating layer may be present between the insulating layer 15h and the insulating layer 15i in the coil-axis direction.

For example, the insulating material of the insulator (insulating layers) is a glass material containing borosilicate glass as a main ingredient; a ceramic material; an organic material, such as epoxy resin, fluororesin, or a polymer resin; or a composite material such as glass-epoxy resin. The insulating material is preferably a material of which the dielectric constant and the dielectric loss are small.

The multiple insulating layers may be made of the same insulating material or of different insulating materials, or some of the insulating layers may be made of the same insulating material.

The insulating layers may have the same thickness or may have different thicknesses in the coil-axis direction, or some of the insulating layers may have the same thickness.

As illustrated in FIG. 1, the coil 20 is formed inside the main body 10 and is wound helically around the coil axis so as to proceed in the coil-axis direction.

The coil-axis direction of the coil 20 is the same as the direction in which a coil axis CA of the coil 20 extends. As described above, the coil-axis direction extends parallel to the bottom surface 12b that is the mounting surface of the main body 10. The coil-axis direction of the coil 20 is the direction extending parallel to the lamination direction of the main body 10

As illustrated in FIGS. 1 and 2, the coil 20 includes multiple coil wires 21 that are electrically connected to each other. The coil wires 21 extend in directions that orthogonally intersect the coil-axis direction, and the coil wires 21 are disposed at different positions in the coil-axis direction.

The inductor component 1A includes two coil wires, in other words, a coil wire 21a and a coil wire 21b that are disposed at different positions in the coil-axis direction.

In the example illustrated in FIG. 2, the coil wire 21a is made by laminating a coil conductor layer 121aa, a coil conductor layer 121ab, and a coil conductor layer 121ac together in the coil-axis direction. In addition, the coil wire 21b is made by laminating a coil conductor layer 121ba, a coil conductor layer 121bb, and a coil conductor layer 121bc together in the coil-axis direction.

At least one coil conductor layer of another type may be further laminated in the coil-axis direction in the coil wire 21a in addition to the above coil conductor layers. At least one coil conductor layer of another type may be further laminated in the coil-axis direction in the coil wire 21b in addition to the above coil conductor layers.

Note that at least one coil wire of another type may be provided between the coil wire 21a and the coil wire 21b in the coil-axis direction.

The coil wires 21 are made of a conductive material, such as Ag, Au, Cu, Pd, Ni, Al, or an alloy containing at least one of these.

The coil wires 21 may be made of the same conductive material or of different conductive materials, or some of the coil wires 21 may be made of the same conductive material.

The coil wires 21 may have the same thickness or may have different thicknesses in the coil-axis direction, or some of the coil wires 21 may have the same thickness.

The coil wires 21 may have the same thickness when each coil wire 21 is measured in a width direction w1 (see FIG. 1), in other words, when each coil wire 21 is measured in a direction orthogonal to both the coil-axis direction and the extending direction of the coil wire 21. The coil wires 21 may have different thicknesses in the width direction w1, or some of the coil wires 21 may have the same thickness.

Adjacent ones of the coil wires 21 may be electrically connected to each other by a via conductor that pierces through an insulating layer between the adjacent coil wires 21 in the coil-axis direction or may be electrically connected directly without using the via conductor. In other words, the coil 20 may be made by electrically connecting the coil wires 21 to each other using the via conductor, the coil wires 21 being disposed at different positions in the coil-axis direction. The coil wires 21 may be connected directly without using the via conductor.

In the example illustrated in FIG. 2, the coil wire 21a and the coil wire 21b are electrically connected to each other by a via conductor 29a that pierces through the insulating layer 15e in the coil-axis direction.

The via conductor 29a is made of a via conductor layer 129aa in the example illustrated in FIG. 2.

At least one via conductor layer of another type may be further laminated in the coil-axis direction in the via conductor 29a in addition to the via conductor layer 129aa.

The via conductor 29a may have a single-layer structure or may have a multilayer structure.

The via conductor 29a is made of a conductive material, such as Ag, Au, Cu, Pd, Ni, Al, or an alloy containing at least one of these.

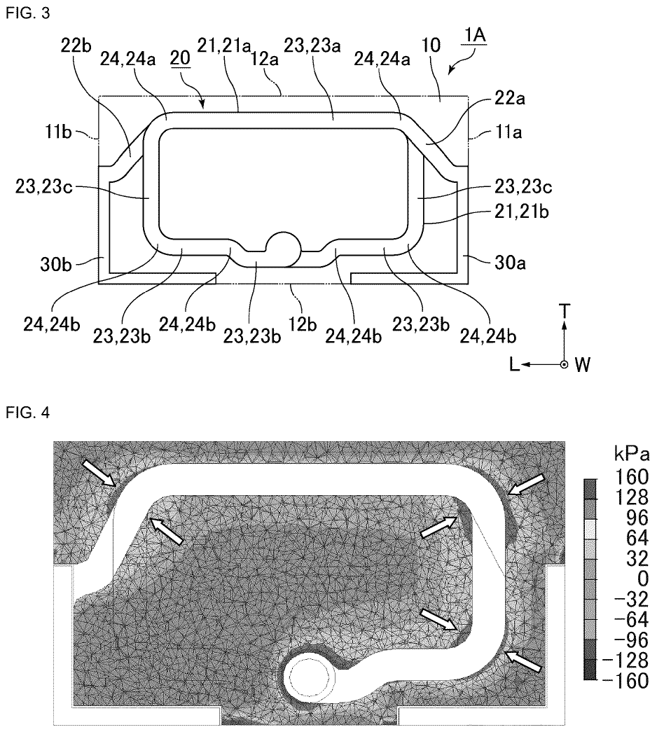

FIG. 3 is a plan view schematically illustrating the example of the inductor component of FIG. 1 as viewed in the coil-axis direction.

As illustrated in FIG. 3, the coil wires 21 include straight portions 23 and curved portions 24 as viewed in the coil-axis direction.

A plurality of the coil wires 21 disposed at different positions has the straight portions 23 and the curved portions 24, which shapes the coil 20 that has the straight portions 23 and the curved portions 24 as viewed in the coil-axis direction. For example, the coil 20 may have a polygonal shape as illustrated in FIG. 3 or may have a shape like a running track (to be described later) or a shape like a heart.

As illustrated in FIG. 1, one end portion of the coil 20 is electrically connected to the first outer electrode 30a via the first extended wire 22a.

In the example illustrated in FIG. 2, the first extended wire 22a is made of a first extended conductor layer 122aa, a first extended conductor layer 122ab, and a first extended conductor layer 122ac.

The first extended wire 22a may be made by further laminating at least one extended conductor layer of another type in the coil-axis direction in addition to the above first extended conductor layers.

The first extended wire 22a may have a single-layer structure or may have a multilayer structure.

As illustrated in FIG. 1, the opposite end portion of the coil 20 is electrically connected to the second outer electrode 30b via the second extended wire 22b.

In the example illustrated in FIG. 2, the second extended wire 22b is made of a second extended conductor layer 122ba, a second extended conductor layer 122bb, and a second extended conductor layer 122bc.

The second extended wire 22b may be made by further laminating at least one extended conductor layer of another type in the coil-axis direction in addition to the above second extended conductor layers.

The second extended wire 22b may have a single-layer structure or may have a multilayer structure.

The extended wires are made of a conductive material, such as Ag, Au, Cu, Pd, Ni, Al, or an alloy containing at least one of these.

The first extended wire 22a and the second extended wire 22b may be made of the same conductive material or of different conductive materials.

In the present specification, the extended wires are wires that do not overlap, or protrude from, the loop portion of the coil when the coil is viewed in the coil-axis direction.

As illustrated in FIG. 1, the first outer electrode 30a is exposed at a surface of the main body 10.

It is preferable that the first outer electrode 30a be exposed at least at the bottom surface 12b of the main body 10 as illustrated in FIG. 1.

In the example illustrated in FIG. 1, the first outer electrode 30a extends on part of the bottom surface 12b of the main body 10 and further onto part of the end surface 11a. In other words, in the example illustrated in FIG. 1, the first outer electrode 30a is exposed on the part of the bottom surface 12b of the main body 10 and also on the part of the end surface 11a of the main body 10.

Note that the first outer electrode 30a may be exposed only at the bottom surface 12b of the main body 10.

In the example illustrated in FIG. 2, the first outer electrode 30a is made by laminating a first outer conductor layer 130aa, a first outer conductor layer 130ab, a first outer conductor layer 130ac, a first outer conductor layer 130ad, a first outer conductor layer 130ae, a first outer conductor layer 130af, and a first outer conductor layer 130ag together in the coil-axis direction.

In the first outer electrode 30a, at least one outer conductor layer of another type may be further laminated in the coil-axis direction in addition to the above first outer conductor layers.

The first outer electrode 30a may have a single-layer structure or may have a multilayer structure.

As illustrated in FIG. 1, the second outer electrode 30b is exposed at a surface of the main body 10.

It is preferable that the second outer electrode 30b be exposed at least at the bottom surface 12b of the main body 10 as illustrated in FIG. 1.

In the example illustrated in FIG. 1, the second outer electrode 30b extends on part of the bottom surface 12b of the main body 10 and further onto part of the end surface 11b. In other words, in the example illustrated in FIG. 1, the second outer electrode 30b is exposed on the part of the bottom surface 12b of the main body 10 and also on the part of the end surface 11b of the main body 10.

Note that the second outer electrode 30b may be exposed only at the bottom surface 12b of the main body 10.

In the example illustrated in FIG. 2, the second outer electrode 30b is made by laminating a second outer conductor layer 130ba, a second outer conductor layer 130bb, a second outer conductor layer 130bc, a second outer conductor layer 130bd, a second outer conductor layer 130be, a second outer conductor layer 130bf, and a second outer conductor layer 130bg together in the coil-axis direction.

In the second outer electrode 30b, at least one outer conductor layer of another type may be further laminated in the coil-axis direction in addition to the above second outer conductor layers.

The second outer electrode 30b may have a single-layer structure or may have a multilayer structure.

It is preferable that as described above, the first outer electrode 30a and the second outer electrode 30b be exposed at least at the bottom surface 12b of the main body 10 so as to be spaced from each other. In the example illustrated in FIG. 1, the first outer electrode 30a and the second outer electrode 30b are spaced from each other in the direction orthogonally intersecting the coil-axis direction (in this case, in the length direction L).

The exposure of the first outer electrode 30a and the second outer electrode 30b at the bottom surface 12b of the main body 10, which is the mounting surface, leads to an improvement in the mountability of the inductor component 1A.

In the example illustrated in FIG. 1, the dimension of the first outer electrode 30a in the coil-axis direction is smaller than the dimension of the main body 10 in the coil-axis direction.

Note that the dimension of the first outer electrode 30a may be equal to the dimension of the main body 10 in the coil-axis direction.

In the example illustrated in FIG. 1, the dimension of the second outer electrode 30b in the coil-axis direction is smaller than the dimension of the main body 10 in the coil-axis direction.

Note that the dimension of the second outer electrode 30b may be equal to the dimension of the main body 10 in the coil-axis direction.

The first outer electrode 30a and the second outer electrode 30b are made of a conductive material, such as Ag, Au, Cu, Pd, Ni, Al, or an alloy containing at least one of these.

The first outer electrode 30a may include, from the side closer to the coil 20, a base layer containing the above conductive material (such as Ag), a Ni-plating layer, and a Sn-plating layer. In the first outer electrode 30a, the base layer may be formed so as to be flush with the surface of the main body 10 (more specifically, flush with the end surface 11a and the bottom surface 12b of the main body 10 in FIG. 1), and the Ni-plating layer and the Sn-plating layer may rise from the surface of the main body 10 (more specifically, rise from the end surface 11a and the bottom surface 12b of the main body 10 in FIG. 1) so as to cover the base layer.

The second outer electrode 30b may include, from the side closer to the coil 20, a base layer containing the above conductive material (such as Ag), a Ni-plating layer, and a Sn-plating layer. In the second outer electrode 30b, the base layer may be formed so as to be flush with the surface of the main body 10 (more specifically, flush with the end surface 11b and the bottom surface 12b of the main body 10 in FIG. 1), and the Ni-plating layer and the Sn-plating layer may rise from the surface of the main body 10 (more specifically, rise from the end surface 11b and the bottom surface 12b of the main body 10 in FIG. 1) so as to cover the base layer.

The first outer electrode 30a and the second outer electrode 30b may be made of the same conductive material or of different conductive materials.

As illustrated in FIG. 1, at least one of the curved portions 24 may have a cut-away section 51 that extends partially across the coil wire in the coil-axis direction. The wire thickness in the coil-axis direction at the cut-away section 51 is smaller than the wire thickness in the coil-axis direction at the straight portion 23.

FIG. 4 is a view illustrating a distribution of residual stress of a known inductor component after sintering.

As illustrated in FIG. 4, after the inductor component is sintered, a large stress normally remains near curved portions of the coil wire (for example, portions indicated by arrows in FIG. 4). The inductor component 1A has the cut-away section 51 at at least one curved portion 24, the cut-away section 51 extending partially across the coil wire in the coil-axis direction, and the wire thickness in the coil-axis direction at the cut-away section 51 is thereby made smaller than the wire thickness in the coil-axis direction at the straight portion 23. This can reduce the volume of the coil wire 21 at the curved portion 24 where a large residual stress acts after sintering and thereby reduce the stress resultant for the region. As a result, the inductor component 1A can control the degradation of the resistance against external impact, which can reduce the occurrence of cracks or the like.

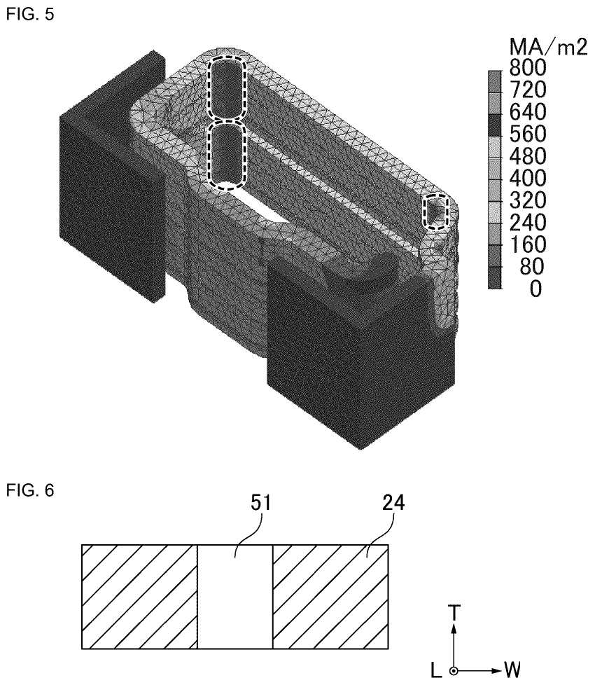

FIG. 5 is a view illustrating a distribution of density of direct current flowing in a coil of a known inductor component.

As illustrated in FIG. 5, the current generally concentrates in an inner region of the curved portion (for example, regions surrounded by dotted lines in FIG. 5) since the current path is shortest in the inner region. In other words, in the curved portion, only part of the cross-sectional area of the coil wire can serve as the current path effectively. The inductor component 1A has the cut-away section 51 at the curved portion 24. As a result, the inductor component 1A can control the degradation of the resistance against external impact while controlling the degradation of the Q characteristics that is caused by decreasing the cross-sectional area of the coil wire 21 compared with a case where the cut-away section 51 is formed at a straight portion 23 of which the entire cross-sectional area serves as the current path.

Accordingly, the inductor component 1A can reduce the occurrence of cracks or the like while controlling the degradation of the Q characteristics.

The above expression “the wire thickness in the coil-axis direction at the cut-away section” as used herein means the thickness of the coil wire in the coil-axis direction at a position where the cut-away section is formed, in other words, the thickness of the portion of the coil wire at the curved portion where the cut-away section is formed. Note that as illustrated in FIG. 1, “the wire thickness in the coil-axis direction at the cut-away section” can be a thickness t1 of any one of the portions of the coil wire that are separated by the cut-away section 51 or can be a sum of thicknesses t1 of respective portions of the coil wire that are separated by the cut-away section 51.

The above expression “the wire thickness in the coil-axis direction at the straight portion” as used herein means the thickness in the coil-axis direction (see thickness t2 in FIG. 1) of the straight portion of the same coil wire that has the cut-away section at which the thickness is compared.

In FIG. 1, the thickness t1 of any one of the portions of the coil wire separated by the cut-away section 51 is smaller than the thickness t2 of the coil wire at the straight portion, and the sum of the thicknesses t1 of the portions of the coil wire separated by the cut-away section 51 is also smaller than the thickness t2 of the coil wire at the straight portion.

Note that in the inductor component of the present disclosure, the first extended wire and the second extended wire do not have any cut-away section formed therein.

As illustrated in FIG. 3, the coil 20 is shaped like a polygon as viewed in the coil-axis direction. The straight portions 23 of the coil 20 include one first straight portion 23a positioned closer to the top surface and one or more second straight portions 23b positioned closer to the mounting surface with respect to a center line passing through the center of the main body 10 in the height direction T. The straight portions 23 also include third straight portions 23c that connect the first straight portion 23a and corresponding second straight portions 23b. The first straight portion 23a and the second straight portions 23b extend parallel to the bottom surface 12b (i.e., the mounting surface). The curved portions 24 of the coil 20 include first curved portions 24a that connect respective third straight portions 23c to the first straight portion 23a. The curved portions 24 also include second curved portions 24b that connect respective third straight portions 23c to the corresponding second straight portions 23b and that connect adjacent second straight portions 23b to one another. This enables the coil wires 21 to be sized as large as possible within the main body, thereby increasing the cross-sectional area of the coil 20 and accordingly improving the acquisition efficiency of L-value.

As illustrated in FIG. 1, the inductor component 1A equipped with the coil 20 described above has the cut-away section 51 formed at at least one of the first curved portions 24a and the second curved portions 24b. The cut-away section 51 extends partially across the coil wire in the coil-axis direction. The wire thickness in the coil-axis direction at the cut-away section 51 is preferably made smaller than the wire thickness in the coil-axis direction at the straight portion 23. In the coil 20 having the shape illustrated in FIG. 3, large residual stresses occur in the first curved portions 24a and the second curved portions 24b to which respective straight portions 23 are connected. Reducing the wire volume by forming the cut-away section 51 can reduce the stress resultant, which can control the degradation of the resistance against external impact and accordingly reduce the occurrence of cracks or the like.

More specifically, as illustrated in FIG. 3, the inductor component 1A includes multiple coil wires 21 to form the coil 20, and each one turn of the coil 20 includes the straight portions 23 and the curved portions 24. The straight portions 23 include one first straight portion 23a positioned closer to the top surface and three second straight portions 23b positioned closer to the mounting surface with respect to the center line passing through the center of the main body 10 in the height direction T. The straight portions 23 also include two third straight portions 23c connecting the first straight portion 23a to the corresponding second straight portions 23b. The curved portions 24 include two first curved portions 24a that connect respective third straight portions 23c to the first straight portion 23a. The curved portions 24 also include four second curved portions 24b that connect the third straight portions 23c to the corresponding second straight portions 23b and also connect adjacent second straight portions 23b to one another. The first straight portion 23a and the second straight portions 23b extend parallel to the bottom surface 12b, in other words, the mounting surface. The first curved portion 24a of each coil wire 21 has the cut-away section 51 that extends partially across the coil wire in the coil-axis direction (see FIG. 1).

FIG. 6 is an example schematic cross section of the inductor component of FIG. 1, the cross section being taken along line a1-a2.

As illustrated in FIGS. 1 and 6, the inductor component 1A has the cut-away section 51 formed in the middle of the curved portion 24 in the coil-axis direction. The thickness of the coil wire 21 in the coil-axis direction is divided by the cut-away section 51 formed in the middle of the curved portion 24 in the coil-axis direction. Accordingly, the region of the high stress resultant can be divided while securing a sufficient cross-sectional area of the curved portion 24, which can control the degradation of the resistance against external impact while controlling the degradation of the Q characteristics.

Note that as illustrated in FIG. 2, the coil wire 21a is formed by laminating the coil conductor layer 121aa, the coil conductor layer 121ab, and the coil conductor layer 121ac in such a manner that the coil conductor layer 121aa and the coil conductor layer 121ac that have no cut-away section 51 sandwiches the coil conductor layer 121ab having the cut-away section 51 at the curved portion 24. The cut-away section 51 is formed in the middle of the curved portion 24 in the coil-axis direction by laminating the coil conductor layers having no cut-away section 51 and the coil conductor layer having the cut-away section 51 at the curved portion 24 as described above.

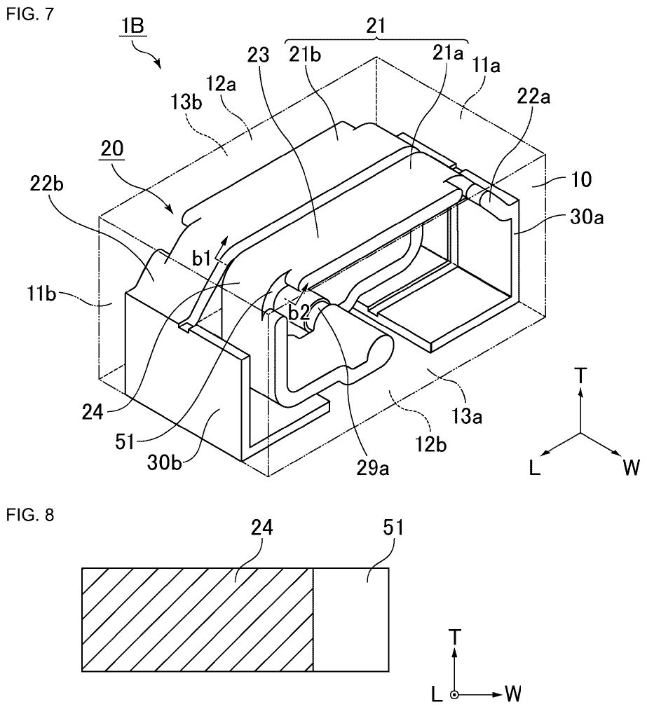

FIG. 7 is a perspective view schematically illustrating another example (Variation 1) of the inductor component of FIG. 1.

FIG. 8 is an example schematic cross section of the inductor component of FIG. 7, the cross section being taken along line b1-b2.

In an inductor component 1B, as illustrated in FIGS. 7 and 8, the cut-away section 51 is located at an end of the curved portion 24 in the coil-axis direction, the end of the curved portion 24 being located closer the side surface 13a of the main body in the coil-axis direction.

In the inductor component 1B, the cut-away section 51 is located at the end of the curved portion 24 that is located closer to the side surface 13a of the main body in the coil-axis direction, which decreases the stress resultant in a region near the surface of the main body 10 where external impacts are transmitted easily. Accordingly, the inductor component 1B can control the degradation of the resistance against external impact more effectively compared with the inductor component 1A. In this case, the cut-away section 51 is preferably formed in the outermost ones of the coil wires 21 in the coil-axis direction.

The above expression “the end of the curved portion that is located closer to the side surface of the main body in the coil-axis direction” includes the end of the curved portion that is positioned closest to a surface of the main body in the coil-axis direction. In FIG. 8, for example, the cut-away section 51 is formed at the end of the curved portion 24 that is positioned closest to the side surface 13a in the direction W.

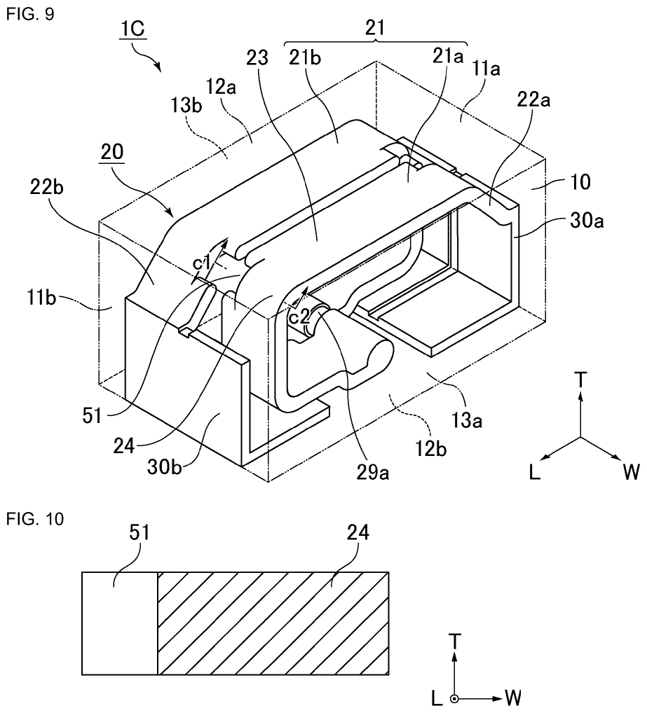

FIG. 9 is a perspective view schematically illustrating another example (Variation 2) of the inductor component of FIG. 1.

FIG. 10 is an example schematic cross section of the inductor component of FIG. 9, the cross section being taken along line c1-c2.

In an inductor component 1C, as illustrated in FIGS. 9 and 10, the cut-away section 51 is located at an end of the curved portion 24 in the coil-axis direction, the end of the curved portion 24 being located closer to a middle of the main body in the coil-axis direction.

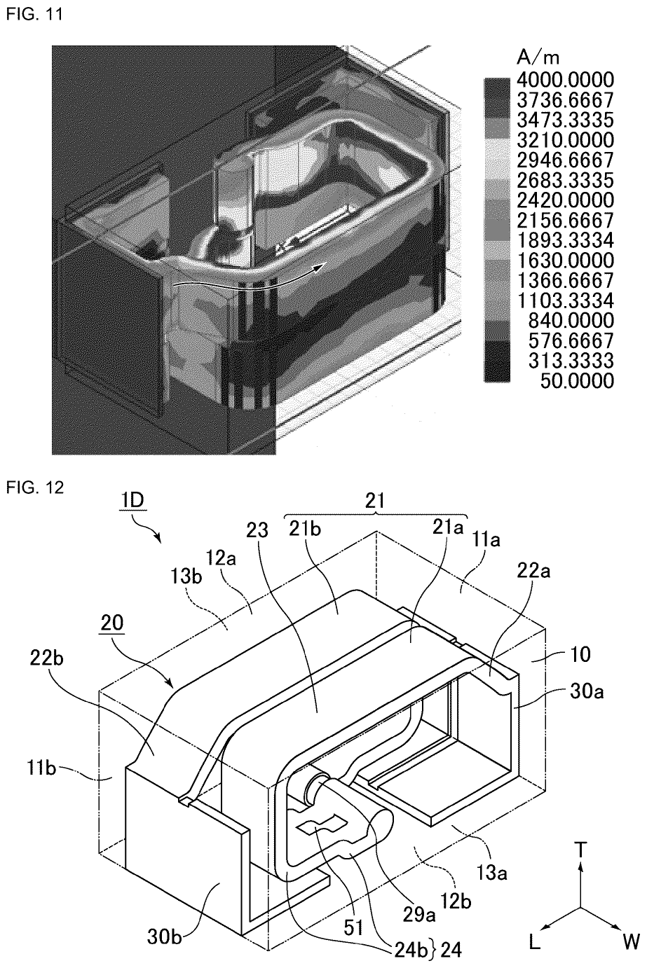

FIG. 11 is a view illustrating a distribution of density of a high-frequency current flowing through a surface of a coil of a known inductor component. FIG. 11 illustrates a result of simulation conducted at 3 GHz.

As illustrated in FIG. 11, high-frequency current generally flows more in portions of the coil 20 that are positioned closer in the coil-axis direction to the corresponding side surfaces of the main body. In the inductor component 1C, the cut-away section 51 is located in the end of the curved portion 24 that is located closer to a middle of the main body in the coil-axis direction, which can decrease the volume of the coil wire 21 while reducing the current reflection loss in a high current-density portion (for example, in the portion indicated by the arrow in FIG. 11). As a result, the inductor component 1C can control the degradation of the resistance against external impact while further controlling the degradation of the Q characteristics compared with the inductor component 1A. In this case, the cut-away section 51 is preferably formed in the outermost ones of the coil wires 21 in the coil-axis direction.

The above expression “the end of the curved portion that is located closer to a middle of the main body in the coil-axis direction” includes the end of the curved portion that is positioned closest to the center of the main body in the coil-axis direction. In FIG. 10, for example, the cut-away section 51 is formed at the end of the curved portion 24 that is positioned closest to the center of the main body in the direction W.

FIG. 12 is a perspective view schematically illustrating another example (Variation 3) of the inductor component of FIG. 1.

In an inductor component 1D, as illustrated in FIG. 12, the cut-away section 51 is formed in the second curved portion 24b that is positioned near the mounting surface. Note that the cut-away section 51 may be formed in the second curved portion 24b that is connected to the third straight portion 23c although in FIG. 12, the cut-away section 51 is formed in the second curved portion 24b that connects adjacent second straight portions 23b.

As illustrated in FIG. 1, the inductor component 1A has the cut-away section 51 formed in the first curved portion 24a positioned near the top surface. As in the inductor component 1A, forming the cut-away section 51 in the curved portion 24 positioned near the top surface decreases the stress resultant in a region of the main body that is not protected at surface by the first outer electrode 30a and the second outer electrode 30b

In the screening step, measurement probes are generally pressed against the mounting surface of the inductor component, which applies an external impact. The inductor component 1D, however, has the cut-away section 51 formed in the curved portion 24 positioned near the mounting surface, which can reduce the stress resultant near a region to which the external impact applies in the screening step and can control the degradation of the resistance against external impact in the region.

Note that the inductor component equipped with the coil 20 shaped in FIG. 3 may include both of the cut-away section 51 formed in the first curved portion 24a positioned near the top surface as in the inductor component 1A illustrated in FIG. 1 and the cut-away section 51 formed in the second curved portion 24b positioned near the mounting surface as in the inductor component 1D illustrated in FIG. 12. In other words, each of the first curved portion 24a and the second curved portion 24b may have at least one cut-away section 51.

The inductor component 1A can be manufactured, for example, in the following process.

### Steps of Manufacturing Mother Multilayer Body

Firstly, an insulating paste containing, for example, a glass material with borosilicate glass as a main ingredient is applied repeatedly by screen printing or the like to form an insulating paste layer that later becomes the insulating layer 15a.

Next, a photosensitive conductive paste containing, for example, a metal such as Ag as a main metal ingredient is applied by screen printing or the like onto the insulating paste layer to form a photosensitive conductive paste layer. Subsequently, the photosensitive conductive paste layer is covered with a photomask and irradiated with, for example, ultraviolet light and subsequently developed using, for example, an alkaline solution to form a coil conductor layer, outer conductor layers, and an extended conductor layer at multiple locations on the insulating paste layer. The extended conductor layer is connected to the coil conductor layer and the outer conductor layer. The coil conductor layer later becomes the coil conductor layer 121ba. The outer conductor layers later become the first outer conductor layer 130aa and the second outer conductor layer 130ba. The extended conductor layer later becomes the second extended conductor layer 122ba.

When the coil conductor layer, the extended conductor layer, and the outer conductor layers are formed, the direct imaging exposure (DI exposure) without using the photomask, for example, may be performed in place of the exposure with the photomask.

Next, for example, the photosensitive insulating paste is applied by screen printing or the like onto the insulating paste layer that later becomes the insulating layer 15a to form new insulating paste layers that later become the insulating layer 15b and the insulating layer 15c. Subsequently, the insulating paste layer that later becomes the insulating layer 15c is covered with a photomask and irradiated with, for example, ultraviolet light and subsequently developed using, for example, an alkaline solution to form a cavity for the coil conductor layer, cavities for the outer conductor layers, and a cavity for the extended conductor layer in such a manner that the cavity for the extended conductor layer is connected to the cavity for the coil conductor layer and to one of the cavities for the outer conductor layers. The cavity for the coil conductor layer is shaped so as to overlap the coil conductor layer that later becomes the coil conductor layer 121ba except for the cut-away section and has the same shape as that of a coil conductor layer that later becomes the coil conductor layer 121bb. The cavity for the extended conductor layer formed in this step overlaps the extended conductor layer that later becomes the second extended conductor layer 122ba. The cavities for the outer conductor layers formed in this step overlap the outer conductor layers that later becomes the first outer conductor layer 130aa and the second outer conductor layer 130ba.

For example, when the insulating paste layer having the cavities is formed, the DI exposure without using the photomask may be performed in place of the exposure with the photomask.

Next, a photosensitive conductive paste containing, for example, a metal such as Ag as a main metal ingredient is applied by screen printing or the like into the cavities and onto the insulating paste layer that later becomes the insulating layer 15c, thereby forming a new photosensitive conductive paste layer. Subsequently, the photosensitive conductive paste layer is covered with a photomask and irradiated with, for example, ultraviolet light and subsequently developed using, for example, an alkaline solution to form a coil conductor layer that later becomes the coil conductor layer 121bb in the cavity for the coil conductor layer and also form a coil conductor layer that later becomes the coil conductor layer 121bc in such a manner that the coil conductor layer that later becomes the coil conductor layer 121bc is connected to the conductor later that later becomes the coil conductor layer 121bb. Moreover, an extended conductor layer that later becomes the second extended conductor layer 122bb is formed in the cavity for the extended conductor layer, and an extended conductor layer that later becomes the second extended conductor layer 122bc is also formed so as to be connected to the extended conductor layer that later becomes the second extended conductor layer 122bb. Furthermore, an outer conductor layer that later becomes the first outer conductor layer 130ab is formed in one of the cavities for the outer conductor layers so as to be connected to the outer conductor layer that later becomes the first outer conductor layer 130aa, and an outer conductor layer that later becomes the first outer conductor layer 130ac is formed on the outer conductor layer that later becomes the first outer conductor layer 130ab. Furthermore, an outer conductor layer that later becomes the second outer conductor layer 130bb is formed in the other one of the cavities for the outer conductor layers so as to be connected to the outer conductor layer that later becomes the second outer conductor layer 130ba, and an outer conductor layer that later becomes the second outer conductor layer 130bc is formed on the outer conductor layer that later becomes the second outer conductor layer 130bb.

Next, the photosensitive insulating paste is applied by screen printing or the like onto the insulating paste layer that later becomes the insulating layer 15c to form new insulating paste layers that later become the insulating layer 15d and the insulating layer 15e. Subsequently, the insulating paste layer that later becomes the insulating layer 15e is covered with a photomask and irradiated with, for example, ultraviolet light and subsequently developed using, for example, an alkaline solution to form a via-hole and cavities for the outer conductor layers in the insulating paste layer that later becomes the insulating layer 15e. The via-hole formed in this step overlaps an end portion of the coil conductor layer that later becomes the coil conductor layer 121bc and has the same shape as that of a via conductor layer that later becomes the via conductor layer 129aa. The cavities for the outer conductor layers overlap the outer conductor layers that later become the first outer conductor layer 130ac and the second outer conductor layer 130bc.

Next, for example, a photosensitive conductive paste containing a metal such as Ag as a main metal ingredient is applied by screen printing or the like into the via-hole and the cavities and also onto the insulating paste layer that later becomes the insulating layer 15e, thereby forming a new photosensitive conductive paste layer. Subsequently, the photosensitive conductive paste layer is covered with a photomask and irradiated with, for example, ultraviolet light and subsequently developed using, for example, an alkaline solution to form a via conductor layer that later becomes the via conductor layer 129aa in the via-hole and also form a coil conductor layer that later becomes the coil conductor layer 121aa so as to be connected to this via conductor layer. Moreover, an outer conductor layer that later becomes the first outer conductor layer 130ad is formed in one of the cavities for the outer conductor layers so as to be connected to the outer conductor layer that later becomes the first outer conductor layer 130ac, and an outer conductor layer that later becomes the first outer conductor layer 130ae is formed on the outer conductor layer that later becomes the first outer conductor layer 130ad. Furthermore, an outer conductor layer that later becomes the second outer conductor layer 130bd is formed in the other one of the cavities for the outer conductor layers so as to be connected to the outer conductor layer that later becomes the second outer conductor layer 130bc, and an outer conductor layer that later becomes the second outer conductor layer 130be is formed on the outer conductor layer that later becomes the second outer conductor layer 130bd. An coil conductor layer that later becomes the coil conductor layer 121aa and an extended conductor layer that later becomes the first extended conductor layer 122aa are formed on the insulating paste layer that later becomes the insulating layer 15e in such a manner that the extended conductor layer that later becomes the first extended conductor layer 122aa is connected to the outer conductor layer that later becomes the first outer conductor layer 130ae.

For example, when the via conductor layer and the outer conductor layers are formed, the DI exposure without using the photomask may be performed in place of the exposure with the photomask.

Insulating paste layers that later become the insulating layers 15f, 15g, and 15h are formed in a manner similar to that described above while forming remaining coil conductor layers, extended conductor layers, and outer conductor layers.

Lastly, an insulating paste layer that later becomes the insulating layer 15i is formed by repeatedly applying an insulating paste containing, for example, a glass material with borosilicate glass as a main ingredient using screen printing or the like.

The mother multilayer body is thus manufactured.

The method of patterning conductor traces of the coil conductor layer, the extended conductor layers, the via conductor layer, and the outer conductor layers are not limited to the above-described photolithography. For example, the conductive paste may be applied using a screen-printing plate having openings that correspond to the conductor traces. Alternatively, a conductive film may be first formed using sputtering, vapor deposition, or pressure bonding of a foil, and the conductive film is subsequently etched to form the conductor traces. Alternatively, the semi-additive process may be used to form a negative pattern of the conductor traces for subsequent plating, and unwanted portions of the plated film may be etched away to leave the conductor traces.

When forming the coil conductor layers, the extended conductor layers, the via conductor layer, and the outer conductor layers, the conductor traces can be built up in a multilayered manner to increase the aspect ratio of conductor trace, thereby reducing the resistive loss of high-frequency current. The method of building up the conductor traces in the multilayered manner is not limited to the above method, in other words, the method of repeating the steps using the photolithography. The conductor traces may be built up repeatedly using the semi-additive process. Alternatively, the conductor traces may be formed first using the semi-additive process, and subsequently new conductor traces may be formed over the previously formed conductor traces using plating and etching, and vice versa. Alternatively, the conductor traces formed using the semi-additive process may be built up by further plating.

The conductive material of the conductor traces of the coil conductor layer, the extended conductor layer, the via conductor layer, and the outer conductor layers is not limited to the above-described photosensitive conductive paste containing a metal such as Ag as a main metal ingredient. The conductive material may be a material containing a metal such as Ag, Au, or Cu to form these conductor layers using sputtering, vapor deposition, pressure bonding of a foil, plating, or the like.

The method of forming the insulating paste layer is not limited to the above-described photolithography but may be pressure bonding of an insulating sheet or spin-coating or spray-coating of an insulating material.

The method of forming the insulating paste layer having the via-hole and the cavities is not limited to the above-described photolithography. For example, an insulating film may be formed first using pressure bonding of an insulating sheet, spin-coating or spray-coating of an insulating material, or the like, and subsequently the via-hole and the cavities may be formed in the insulating film using laser or drilling or the like.

The insulating material of the insulating paste layer is not limited to the above-described glass material containing borosilicate glass as a main ingredient. For example, the insulating material may be a ceramic material; an organic material, such as epoxy resin, fluororesin, or a polymer resin; or a composite material such as glass-epoxy resin. The insulating material is preferably a material of which the dielectric constant and the dielectric loss are small.

### Steps of Forming Main Body, Coil, and Outer Electrodes

The mother multilayer body is cut into multiple unsintered multilayer bodies using, for example, a dicing machine.

An unsintered multilayer body includes a laminated insulating-paste portion formed by laminating the insulating paste layers, a laminated coil conductor portion formed by laminating the coil conductor layers in such a manner that adjacent coil conductor layers are electrically connected by the via conductor layer, and laminated outer conductor portions formed by laminating the outer conductor layers.

For example, when the mother multilayer body is cut into unsintered multilayer bodies, the unsintered multilayer bodies are separated at respective laminated outer conductor portions in such a manner that the laminated outer conductor portions of each multilayer body are exposed at two positions at least at the bottom surface of the laminated insulating-paste portion.

Next, each unsintered multilayer body is sintered to produce a multilayer body.

By sintering the unsintered multilayer body, the insulating paste layer becomes the insulating layer, and accordingly the laminated insulating-paste portion becomes the main body 10. By sintering the unsintered multilayer body, each coil conductor layer becomes the coil wire 21, and accordingly the laminated coil conductor portion becomes the coil 20. By sintering the unsintered multilayer body, one of the two laminated outer conductor portions becomes part of the first outer electrode 30a and the other becomes part of the second outer electrode 30b.

Next, the multilayer body obtained may be subjected to barrel polishing to round edges and vertices of the main body 10.

Finally, the two laminated outer conductor portions of the sintered multilayer body are plated to form outer electrodes. The laminated outer conductor portions serve as base layers, and Ni-plating layers are formed on respective base layers, and subsequently Sn-plating layers are formed on respective Ni-plating layers. For example, the thickness of the Ni-plating layer and the Sn-plating layer is each 2 μm or more and 10 μm or less (i.e., from 2 μm to 10 μm).

Thus, each of the first outer electrode 30a and the second outer electrode 30b is formed so as to have the base layer, the Ni-plating layer, and the Sn-plating layer laminated in this order from the surface of the main body 10. In the first outer electrode 30a, the base layer may be formed so as to be flush with the surface of the main body 10 (more specifically, flush with the end surface 11a and the bottom surface 12b of the main body 10 in FIG. 1), and the Ni-plating layer and the Sn-plating layer may rise from the surface of the main body 10 (more specifically, rise from the end surface 11a and the bottom surface 12b of the main body 10 in FIG. 1) so as to cover the base layer. In the second outer electrode 30b, the base layer may be formed so as to be flush with the surface of the main body 10 (more specifically, flush with the end surface 11b and the bottom surface 12b of the main body 10 in FIG. 1), and the Ni-plating layer and the Sn-plating layer may rise from the surface of the main body 10 (more specifically, rise from the end surface 11b and the bottom surface 12b of the main body 10 in FIG. 1) so as to cover the base layer.

The method of forming the outer electrodes is not limited to the above method, in other words, the method of plating the laminated outer conductor portions exposed at the cut surfaces (for example, at least at the bottom surface of the laminated insulating-paste portion) of the unsintered multilayer body. For example, the laminated outer conductor portions may be exposed first at respective cut surfaces (for example, at least at the bottom surface of the laminated insulating-paste portion) of the unsintered multilayer body, and the exposed portions may be dipped in the conductive paste or may be covered with the conductive paste by sputtering, and subsequently the exposed portions may be subjected to plating.

The inductor component 1A is thus produced.

The inductor component 1A is produced as a so-called “0402 size” product (having the dimensions of 0.4 mm by 0.2 mm by 0.2 mm). The size of the inductor component 1A is not limited to the “0402 size” (i.e., 0.4 mm by 0.2 mm by 0.2 mm).

### Embodiment 2

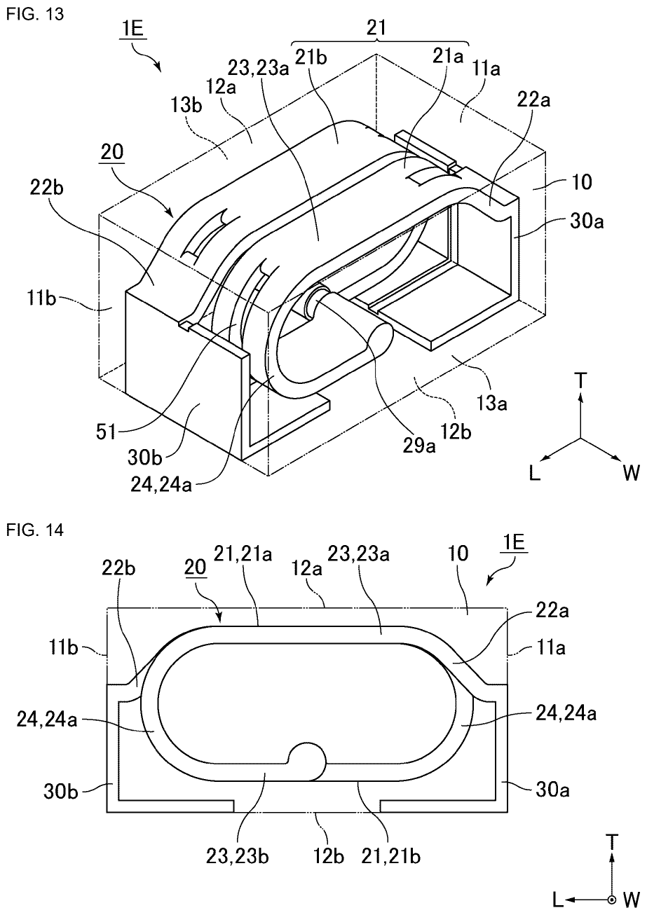

FIG. 13 is a perspective view schematically illustrating an example of an inductor component according to Embodiment 2 of the present disclosure.

As illustrated in FIG. 13, the coil 20 of an inductor component 1E includes two coil wires, in other words, the coil wire 21a and the coil wire 21b.

FIG. 14 is a plan view schematically illustrating the example of the inductor component of FIG. 13 as viewed in the coil-axis direction.

As illustrated in FIG. 14, the straight portions 23 of the coil 20 include one first straight portion 23a positioned closer to the top surface and at least one second straight portion 23b positioned closer to the mounting surface with respect to the center line passing through the center of the main body 10 in the height direction T. The first straight portion 23a and the second straight portion 23b extend parallel to the mounting surface. The curved portions 24 of the coil 20 include first curved portions 24a that connect the first straight portion 23a and the second straight portion 23b. Accordingly, the first straight portion 23a and the second straight portion 23b are connected by arcuate first curved portions 24a, which can reduce the reflection loss at the connection points and thereby increase the Q-value. As illustrated, the coil 20 may be shaped like a running track (or like an ellipse) as viewed in the coil-axis direction.

As illustrated in FIG. 13, the inductor component 1E equipped with the coil 20 described above has the cut-away section 51 formed at at least one of the first curved portions 24a, and the cut-away section 51 extends partially across the coil wire in the coil-axis direction. The wire thickness in the coil-axis direction at the cut-away section 51 is preferably made smaller than the wire thickness in the coil-axis direction at the straight portions 23. In the coil 20 having the shape illustrated in FIG. 14, large residual stresses occur in the first curved portions 24a that connect the first straight portion 23a and the second straight portion 23b. Reducing the wire volume by forming the cut-away section 51 as described above can reduce the stress resultant, which can control the degradation of the resistance against external impact and accordingly reduce the occurrence of cracks or the like

More specifically, as illustrated in FIG. 14, the inductor component 1E includes multiple coil wires 21 to form the coil 20, and each one turn of the coil 20 includes the straight portions 23 and the curved portions 24. The straight portions 23 include one first straight portion 23a positioned closer to the top surface and one second straight portion 23b positioned closer to the mounting surface with respect to the center line passing through the center of the main body 10 in the height direction T. The curved portions 24 include two first curved portions 24a that connect the first straight portion 23a and the second straight portion 23b. The first straight portion 23a and the second straight portion 23b extend parallel to the bottom surface 12b, which is the mounting surface. The first curved portion 24a of each coil wire 21 has the cut-away section 51 that extends partially across the coil wire in the coil-axis direction (see FIG. 13).

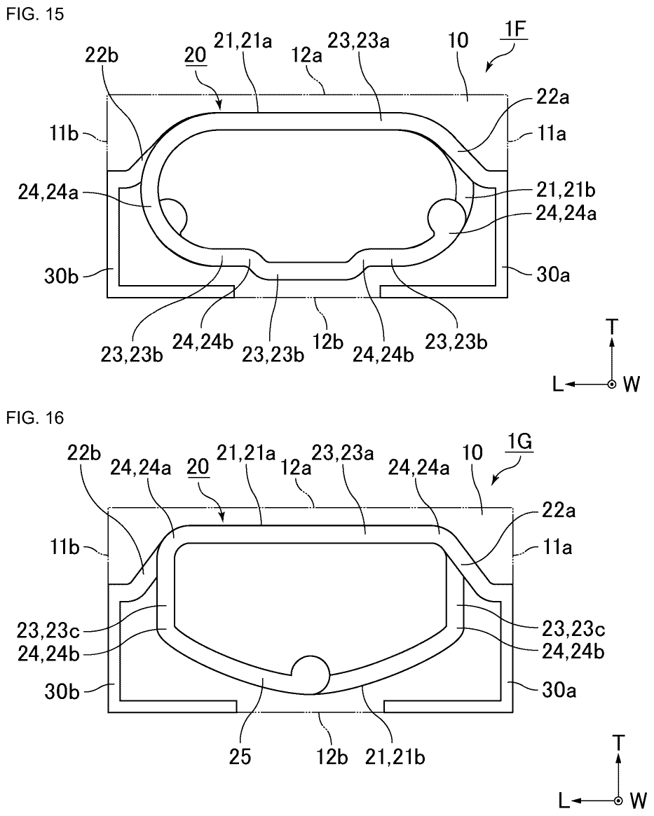

FIG. 15 is a plan view schematically illustrating another example (Variation 1) of the inductor component of FIG. 13 as viewed in the coil-axis direction.

As is the case for an inductor component IF illustrated in FIG. 15, the inductor component may further include three second straight portions 23b and additional curved portions 24, in other words, additional two second curved portions 24b. The additional two second curved portions 24b connect adjacent second straight portions 23b to each other. In other words, the shape of the coil 20 of the inductor component 1F near the mounting surface may be similar to that of the coil 20 of the inductor component 1A illustrated in FIG. 3. This enables the coil wires 21 to be sized largely in the main body, thereby increasing the cross-sectional area of the coil 20 and accordingly improving the acquisition efficiency of L-value, as is the case for the inductor component 1A.

In the inductor component 1F equipped with the coil 20, the cut-away section 51 that extends partially across the coil wire in the coil-axis direction may be formed in at least one second curved portion 24b that is positioned near the mounting surface, as is the case for the inductor component 1D. Accordingly, as is the case for the inductor component 1D, the cut-away section 51 of the inductor component IF can reduce the stress resultant near a region to which the external impact applies in the screening step and thereby control the degradation of the resistance against external impact in the region.

### Embodiment 3

FIG. 16 is a plan view schematically illustrating an example of an inductor component according to Embodiment 3 of the present disclosure.

When the coil wires 21 are viewed in the coil-axis direction, as illustrated in FIG. 16, the coil wires 21 include one arc portion 25 near the mounting surface with respect to the center line passing through the center of the main body 10 in the height direction T. The arc portion 25 protrude toward the mounting surface. The coil wires 21 also include one straight portion 23, in other words, one first straight portion 23a, near the top surface with respect to the center line. The first straight portion 23a extends parallel to the mounting surface. The curved portions 24 include the first curved portions 24a that are directly connected to the first straight portion 23a and electrically connected to both the first straight portion 23a and the arc portion 25. This can increase the distance between the portion of the coil wire 21 positioned near the mounting surface and the first outer electrode 30a and the second outer electrode 30b that are formed at the mounting surface, thereby reducing the stray capacitance and improving the high-frequency characteristics of the Q-value. This leads to an increase in the Q-value. As viewed in the coil-axis direction, the coil 20 may be shaped like a heart, in other words, shaped such that the coil wires 21 has one arc portion 25 near the mounting surface and the arc portion 25 protrudes toward the mounting surface.

The inductor component 1G equipped with the coil 20 described above has the cut-away section 51 that is formed at at least one of the first curved portions 24a so as to extend partially across the coil wire in the coil-axis direction. The wire thickness in the coil-axis direction at the cut-away section 51 is preferably made smaller than the wire thickness in the coil-axis direction at the straight portion 23. The cut-away section 51 is formed as described above in the curved portion 24 where large residual stress occurs after sintering. The cut-away section 51 can reduce the volume of the coil wire 21 at the curved portion 24 and thereby reduce the stress resultant for the region, which can control the degradation of the resistance against external impact and accordingly reduce the occurrence of cracks or the like.

As in the inductor component 1G illustrated in FIG. 16, the straight portions 23 further includes the third straight portions 23c that connect the first straight portion 23a and the arc portion 25. The first curved portions 24a connect the first straight portion 23a to respective third straight portions 23c. The curved portions 24 may further include the second curved portions 24b that connect the arc portion 25 to respective third straight portions 23c. In other words, the shape of the coil 20 may be similar to that of the coil 20 of the inductor component 1A illustrated in FIG. 3 except for the arc portion 25 that protrudes toward the mounting surface. This enables the coil wires 21 to be sized largely, except for the arc portion 25, within the main body, thereby increasing the cross-sectional area of the coil 20 and accordingly improving the acquisition efficiency of L-value, as is the case for the inductor component 1A.

More specifically, as illustrated in FIG. 16, the inductor component 1G includes multiple coil wires 21 to form the coil 20, and each one turn of the coil 20 includes the arc portion 25, the straight portions 23, and the curved portions 24. The arc portion 25 is positioned closer to the mounting surface with respect to the center line passing through the center of the main body 10 in the height direction T. The straight portions 23 include one first straight portion 23a positioned closer to the top surface and two third straight portions 23c connecting the first straight portion 23 and the arc portion 25a. The curved portions 24 include two first curved portions 24a that connect the first straight portion 23a to respective third straight portions 23c. The curved portions 24 also include two second curved portions 24b that connect the arc portion 25 to respective third straight portions 23c. The first straight portion 23a extend parallel to the bottom surface 12b, which is the mounting surface, and the arc portion 25 protrude toward the mounting surface. The first curved portion 24a of each coil wire 21 has the cut-away section 51 that extends partially across the coil wire in the coil-axis direction.

In the inductor component 1G equipped with the coil 20 described above, the cut-away section 51 that extends partially across the coil wire in the coil-axis direction may be formed at at least one of the second curved portions 24b that are positioned near the mounting surface, as is the case for the inductor component 1D. Accordingly, as is the case for the inductor component 1D, the cut-away section 51 of the inductor component 1G can reduce the stress resultant near a region to which the external impact applies in the screening step and thereby control the degradation of the resistance against external impact in the region.

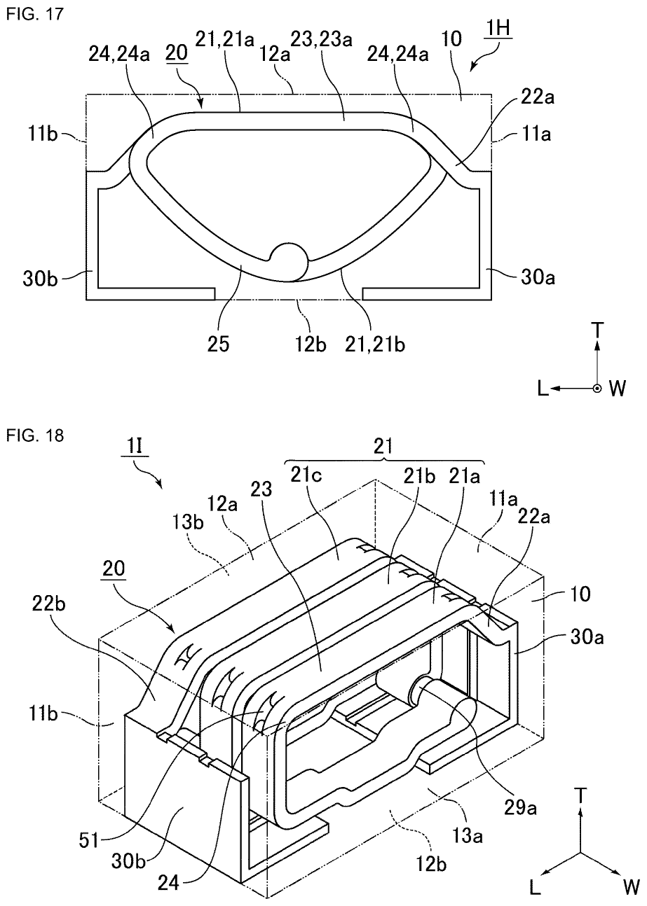

FIG. 17 is a plan view schematically illustrating another example (Variation 1) of the inductor component of FIG. 16.

As in an inductor component 1H illustrated in FIG. 17, the first curved portions 24a may connect the first straight portion 23a directly to the arc portion 25. In other words, the shape of the coil 20 may be similar to that of the coil 20 of the inductor component 1E illustrated in FIG. 14 except for the arc portion 25 that protrude toward the mounting surface. This can further increase the distance between the portion of the coil wire 21 positioned near the mounting surface and the first outer electrode 30a and the second outer electrode 30b that are formed at the mounting surface, thereby reducing the stray capacitance and improving the high-frequency characteristics of the Q-value. This leads to an increase in the Q-value.

More specifically, as illustrated in FIG. 17, the inductor component 1H includes multiple coil wires 21 to form the coil 20, and each one turn of the coil 20 includes the arc portion 25, the straight portion 23 and the curved portions 24. The arc portion 25 is positioned closer to the mounting surface with respect to the center line passing through the center of the main body 10 in the height direction T. As the straight portion 23, one first straight portion 23a is positioned closer to the top surface with respect to the center line. The curved portions 24 include two first curved portions 24a that connect the first straight portion 23a to the arc portion 25. The first straight portion 23a extends parallel to the bottom surface 12b, which is the mounting surface, and the arc portion 25 protrude toward the mounting surface. The first curved portion 24a of each coil wire 21 has the cut-away section 51 that extends partially across the coil wire in the coil-axis direction.

Note that the arc of the arc portion 25 has the imaginary center positioned inside the product in the examples illustrated in FIGS. 16 and 17. The imaginary center of the arc, however, may be positioned outside the product.

It is sufficient that the shape of the arc portion 25 include at least one arc. As illustrated in FIGS. 16 and 17, the shape of the arc portion 25 may also include tangent lines extending from respective ends of the arc.

### Configurations Common to Embodiments 1 to 3

FIG. 18 is a perspective view schematically illustrating another example of the inductor component of FIG. 1.

As illustrated in FIG. 18, an inductor component 1I includes a coil 20 that further includes three tiers of coil wires, in other words, a coil wire 21a, a coil wire 21b, and a coil wire 21c.

In each example of the inductor components described in Embodiments 1 to 3, the coil 20 includes 1.5 turns of the coil wire made of two coil wires 21 disposed in two tiers. The number of turns, however, is not limited to 1.5 turns but may be 2.5 turns or more. In other words, the inductor component may include three tiers or more of coil wires 21. From the view point of controlling the degradation of the resistance against external impact, it is efficient to form the cut-away section 51 in a coil wire 21 of which the thickness in the coil-axis direction is large.

The cut-away section 51 may be formed in all tiers of the coil 20 or may be formed in some of the tiers of the coil 20. Forming the cut-away sections 51 in all of the tiers of the coil 20 is not necessarily preferable. Forming the cut-away sections 51 in all of the tiers of the coil 20 improves the control of the degradation of the resistance against external impact but impairs the control of the degradation of the Q characteristics at the same time.

In the case of the inductor component of which the coil 20 includes three tiers or more of coil wires 21, when the cut-away section 51 is provided in the coil wire 21 positioned at the center of the main body 10 in the coil-axis direction, the cut-away section 51 is to be formed in the middle of the curved portion 24 in the coil-axis direction. For the purpose of controlling the stress resultant, however, it is not necessary to form the cut-away section 51 in the middle of the curved portion 24 in the coil-axis direction. The cut-away section 51 may be formed near either side of the curved portion 24 in the coil-axis direction.

In the case of providing the cut-away sections 51 at multiple curved portions 24, the cut-away sections 51 may be formed in a combined manner, in other words, by adopting at least two of the configurations of the inductor component 1A of FIG. 1, the inductor component 1B of FIG. 7, and the inductor component 1C of FIG. 9. In other words, in the inductor components 1A to 1C, the cut-away section is formed at the edge portion positioned shallower in the main body or in the middle or at the edge portion positioned deeper in the main body. The cut-away section may be formed at two or more of these locations.

Embodiments 1 to 3 describes a single cut-away section formed in one tier of the coil wire 21 so as to extend partially across the curved portion 24 in the coil-axis direction by way of example. Multiple cut-away sections 51 may be formed in one tier of the coil wire 21 so as to extend partially across the curved portion 24 in the coil-axis direction.

The wire thickness in the coil-axis direction at the cut-away section 51 is 1/10 or more and ½ or less (i.e., from 1/10 to ½) of the wire thickness t2 in the coil-axis direction at the straight portion 23. In the case of multiple cut-away sections 51 being formed partially across the curved portion 24 in the coil-axis direction, the wire thickness at the curved portion 24 is the sum of all the thicknesses of the coil wires that have been divided by the cut-away sections 51.

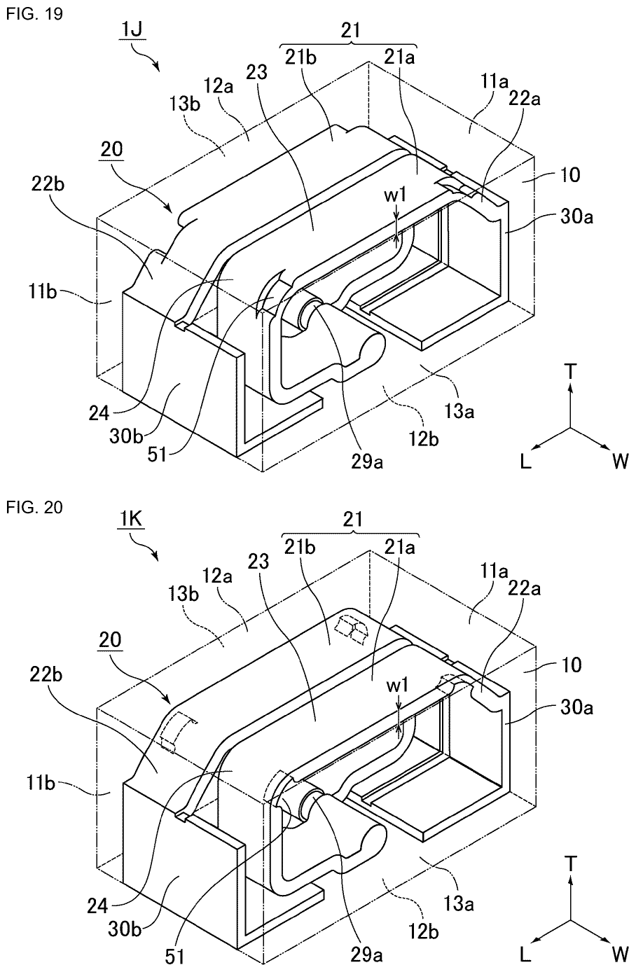

FIG. 19 is a perspective view schematically illustrating another example of the inductor component of FIG. 7. FIG. 20 is a perspective view schematically illustrating another example of the inductor component of FIG. 7.

In the inductor components described in Embodiments 1 to 3, the cut-away section 51 pierces through the curved portion 24 in the width direction w1. Compared with the case in which the cut-away section 51 does not pierce through the curved portion 24 in the width direction w1, this can further reduce the volume of the coil wire 21 at the curved portion 24 and thereby reduce the stress resultant.

On the other hand, as illustrated in FIGS. 19 and 20, the cut-away section 51 does not need to pierce through the curved portion 24 in the width direction w1 in an inductor component 1J or in an inductor component 1K. This can prevent the cross-sectional area of the coil wire 21 from decreasing excessively at the curved portion 24 compared with the case in which the cut-away section 51 pierces through the curved portion 24 in the width direction w1. Accordingly, this can further control the degradation of the Q characteristics.

As in the inductor component 1J of FIG. 19, the cut-away section 51 is formed so as to leave an inner peripheral portion of the curved portion 24 without piercing through the curved portion 24 in the width direction w1. Electric current generally concentrates in the inner peripheral portion at the curved portion 24. Leaving the inner peripheral portion does not largely decrease the cross-sectional area of the coil wire 21 in which the electric current concentrates, which can further control the degradation of the Q characteristics.

As in the inductor component 1K of FIG. 20, the cut-away section 51 is formed so as to leave an outer peripheral portion of the curved portion 24 without piercing through the curved portion 24 in the width direction w1.

In the case of the inductor component with the cut-away section 51 not piercing through the curved portion 24 in the width direction w1, the cut-away section 51 may be formed in the edge portion of the curved portion 24 being positioned shallower in the main body in the coil-axis direction as illustrated in FIGS. 19 and 20. This can reduce the stress resultant for the region near the surface of the main body 10 to which external impacts are transmitted readily, which can control the degradation of the resistance against external impact and accordingly reduce the occurrence of cracks or the like, as in the case for the inductor component 1B.

In the case of the cut-away section 51 not piercing through in the width direction w1 as in the cases of FIGS. 19 and 20, the wire thickness in the coil-axis direction at the cut-away section 51 is obtained by subtracting the thickness of the cut-away section 51 in the coil-axis direction from the entire wire thickness of the curved portion 24 in the coil-axis direction. Accordingly, also in the cases of FIGS. 19 and 20, the wire thickness in the coil-axis direction at the cut-away section 51 is smaller than the wire thickness in the coil-axis direction at the straight portion.

In Embodiments 1 to 3, the cut-away section 51 is formed only in the curved portion 24 by way of example. The cut-away section 51, however, may be formed in the straight portion 23. Note that the cut-away section 51 may be formed only in the straight portion 23 or may be formed in both the straight portion 23 and the curved portion 24.

In Embodiments 1 to 3, the mounting surface extends parallel to the coil-axis direction by way of example. The inductor component of the present disclosure may have the mounting surface extending perpendicular to the coil-axis direction.

What is claimed is:

1. An inductor component comprising:
a main body;
a coil inside the main body and wound helically around a coil axis;
a first outer electrode and a second outer electrode exposed at a surface of the main body;
a first extended wire inside the main body and electrically connecting one end portion of the coil to the first outer electrode; and
a second extended wire inside the main body and electrically connecting an opposite end portion of the coil to the second outer electrode, wherein
the main body includes an insulator,
the main body has a mounting surface extending parallel to a coil-axis direction and a top surface opposite to the mounting surface in a height direction that is perpendicular to the coil-axis direction,
the first outer electrode and the second outer electrode are exposed at least at the mounting surface of the main body and spaced from each other,
the coil includes a plurality of coil wires that are connected electrically to each other,
the coil wires extend in directions perpendicular to the coil-axis direction,
the coil wires are at different positions in the coil-axis direction and are electrically connected to each other,
as viewed in the coil-axis direction, the plurality of coil wires includes at least one straight portion and at least one curved portion,
the at least one curved portion includes a cut-away section at a portion of the at least one curved portion as viewed in the coil-axis direction, and
a wire thickness in the coil-axis direction at the cut-away section is smaller than a wire thickness in the coil-axis direction at the at least one straight portion.

2. The inductor component according to claim 1, wherein
the cut-away section is in a middle of the at least one curved portion in the coil-axis direction.

3. The inductor component according to claim 1, wherein
the cut-away section is at an end of the at least one curved portion in the coil-axis direction, which is closer to a surface of the main body in the coil-axis direction.

4. The inductor component according to claim 1, wherein
the cut-away section is at an end of the at least one curved portion in the coil-axis direction, which is closer to a middle of the main body in the coil-axis direction.

5. The inductor component according to claim 1, wherein
the coil has a polygonal shape as viewed in the coil-axis direction,
the at least one straight portion includes at least one first straight portion, at least one second straight portion, and third straight portions connecting between the at least one first straight portion and the at least one second straight portion,
the first straight portion and the at least one second straight portion extend parallel to the mounting surface,
with respect to a center line passing through a center of the main body in the height direction, the at least one first straight portion is closer to the top surface and the at least one second straight portion is closer to the mounting surface,
the at least one curved portion includes first curved portions that connect the at least one first straight portion to respective third straight portions,
the at least one curved portion includes second curved portions that connect adjacent second straight portions to one another and connect the third straight portions to the corresponding second straight portions,
at least any one of the first curved portions and the second curved portions include the cut-away section at a portion of the at least any one of the first curved portions and the second curved portions as viewed in the coil-axis direction, and
the wire thickness in the coil-axis direction at the cut-away section is smaller than the wire thickness in the coil-axis direction at the at least one straight portion.

6. The inductor component according to claim 5, wherein
the cut-away section is at at least one of the first curved portions.

7. The inductor component according to claim 5, wherein
the cut-away section is at at least one of the second curved portions.

8. The inductor component according to claim 1, wherein
the at least one straight portion includes at least one first straight portion and at least one second straight portion,
with respect to a center line passing through a center of the main body in the height direction, the at least one first straight portion is closer to the top surface and the at least one second straight portion is closer to the mounting surface,
the at least one first straight portion and the at least one second straight portion extend parallel to the mounting surface,
the at least one curved portion includes first curved portions that connect the at least one first straight portion to the at least one second straight portion,
at least one of the first curved portions includes the cut-away section provided at a portion of the at least one of the first curved portions as viewed in the coil-axis direction, and
the wire thickness in the coil-axis direction at the cut-away section is smaller than the wire thickness in the coil-axis direction at the at least one straight portion.

9. The inductor component according to claim 1, wherein
as viewed in the coil-axis direction, the plurality of coil wires includes an arc portion that is closer to the mounting surface with respect to a center line passing through a center of the main body in the height direction,
the arc portion protrudes toward the mounting surface,
the at least one straight portion includes a first straight portion closer to the top surface with respect to the center line passing through the center of the main body in the height direction,
the first straight portion extends parallel to the mounting surface,
the at least one curved portion includes first curved portions connected directly to the first straight portion and connected electrically to the first straight portion and to the arc portion,
at least one of the first curved portions includes the cut-away section at a portion of the at least one of the first curved portions as viewed in the coil-axis direction, and
the wire thickness in the coil-axis direction at the cut-away section is smaller than the wire thickness in the coil-axis direction at the at least one straight portion.

10. The inductor component according to claim 9, wherein
the at least one straight portion further includes third straight portions that are interposed between the first straight portion and the arc portion,
the first curved portions connect the first straight portion to respective third straight portions, and
the at least one curved portion further includes second curved portions that connect the arc portion to respective third straight portions.

11. The inductor component according to claim 9, wherein
the first curved portion connects the first straight portion directly to the arc portion.

12. The inductor component according to claim 1, wherein
when a width direction of each coil wire is defined as a direction orthogonal to both the coil-axis direction and the direction in which the coil wire extends,
the cut-away section penetrates through the at least one curved portion in the width direction.

13. The inductor component according to claim 1, wherein
when a width direction of each coil wire is defined as a direction orthogonal to both the coil-axis direction and the direction in which the coil wire extends,
the cut-away section does not penetrate through the at least one curved portion in the width direction.

14. The inductor component according to claim 2, wherein
the coil has a polygonal shape as viewed in the coil-axis direction,
the at least one straight portion includes at least one first straight portion, at least one second straight portion, and third straight portions connecting between the at least one first straight portion and the at least one second straight portion,
the first straight portion and the at least one second straight portion extend parallel to the mounting surface,
with respect to a center line passing through a center of the main body in the height direction, the at least one first straight portion is closer to the top surface and the at least one second straight portion is closer to the mounting surface,
the at least one curved portion includes first curved portions that connect the at least one first straight portion to respective third straight portions,
the at least one curved portion includes second curved portions that connect adjacent second straight portions to one another and connect the third straight portions to the corresponding second straight portions,
at least any one of the first curved portions and the second curved portions include the cut-away section at a portion of the at least any one of the first curved portions and the second curved portions as viewed in the coil-axis direction, and
the wire thickness in the coil-axis direction at the cut-away section is smaller than the wire thickness in the coil-axis direction at the at least one straight portion.

15. The inductor component according to claim 2, wherein
the coil has a polygonal shape as viewed in the coil-axis direction,
the at least one straight portion includes at least one first straight portion, at least one second straight portion, and third straight portions connecting between the at least one first straight portion and the at least one second straight portion,
the first straight portion and the at least one second straight portion extend parallel to the mounting surface,
with respect to a center line passing through a center of the main body in the height direction, the at least one first straight portion is closer to the top surface and the at least one second straight portion is closer to the mounting surface,
the at least one curved portion includes first curved portions that connect the at least one first straight portion to respective third straight portions,
the at least one curved portion includes second curved portions that connect adjacent second straight portions to one another and connect the third straight portions to the corresponding second straight portions,
at least any one of the first curved portions and the second curved portions include the cut-away section at a portion of the at least any one of the first curved portions and the second curved portions as viewed in the coil-axis direction, and
the wire thickness in the coil-axis direction at the cut-away section is smaller than the wire thickness in the coil-axis direction at the at least one straight portion.

16. The inductor component according to claim 6, wherein
the cut-away section is at at least one of the second curved portions.

17. The inductor component according to claim 2, wherein
the at least one straight portion includes at least one first straight portion and at least one second straight portion,
with respect to a center line passing through a center of the main body in the height direction, the at least one first straight portion is closer to the top surface and the at least one second straight portion is closer to the mounting surface,
the at least one first straight portion and the at least one second straight portion extend parallel to the mounting surface,
the at least one curved portion includes first curved portions that connect the at least one first straight portion to the at least one second straight portion,
at least one of the first curved portions includes the cut-away section provided at a portion of the at least one of the first curved portions as viewed in the coil-axis direction, and
the wire thickness in the coil-axis direction at the cut-away section is smaller than the wire thickness in the coil-axis direction at the at least one straight portion.

18. The inductor component according to claim 2, wherein
as viewed in the coil-axis direction, the plurality of coil wires includes an arc portion that is closer to the mounting surface with respect to a center line passing through a center of the main body in the height direction,
the arc portion protrudes toward the mounting surface,
the at least one straight portion includes a first straight portion closer to the top surface with respect to the center line passing through the center of the main body in the height direction,
the first straight portion extends parallel to the mounting surface,
the at least one curved portion includes first curved portions connected directly to the first straight portion and connected electrically to the first straight portion and to the arc portion,
at least one of the first curved portions includes the cut-away section at a portion of the at least one of the first curved portions as viewed in the coil-axis direction, and
the wire thickness in the coil-axis direction at the cut-away section is smaller than the wire thickness in the coil-axis direction at the at least one straight portion.

19. The inductor component according to claim 2, wherein
when a width direction of each coil wire is defined as a direction orthogonal to both the coil-axis direction and the direction in which the coil wire extends,
the cut-away section penetrates through the at least one curved portion in the width direction.

20. The inductor component according to claim 2, wherein
when a width direction of each coil wire is defined as a direction orthogonal to both the coil-axis direction and the direction in which the coil wire extends,
the cut-away section does not penetrate through the at least one curved portion in the width direction.
